(19) United States
(12) Patent Application Publication
(10) Pub. No.: US 2026/0195206 A1
(43) Pub. Date: Jul. 9, 2026

(54) LOG ANALYSIS BASED ON CHARACTER RATIO FEATURES

(71) Applicant: International Business Machines Corporation, Armonk, NY (US)

(72) Inventors: Xiao Dong Wang, BEIJING (CN); Pei Ci Fang, BEIJING (CN); Ding Guo Wang, BEIJING (CN); Yu Dong Wang, BEIJING (CN); Xiao Ping Zheng, BEIJING (CN); Yang Yan, BEIJING (CN); Ling Zhuo, BEIJING (CN)

(73) Assignee: International Business Machines Corporation, Armonk, NY (US)

(21) Appl. No.: 19/013,195

(22) Filed: Jan. 8, 2025

(51) Int. Cl. G06F 11/07

(52) U.S. Cl. CPC G06F 11/0772; G06F 11/0721; G06F 11/0793

(57) ABSTRACT

A computer-implemented technique of log analysis includes tokenizing each of a plurality of log entries in at least one log documenting operations performed by a plurality of computer system components of a computing environment. The tokenization forms multiple tokens for each log entry. Character ratio metrics for each of the multiple tokens are calculated. Based on the character ratio metrics, sentence vectors representing the plurality of log entries are formed. Based on the sentence vectors, an abnormal log entry indicative of deviation of a computer system component from its baseline cyclical behavior is detected in the at least one log, and an alert of the detection is generated.

### BACKGROUND OF THE INVENTION

The present invention relates in general to data processing, and more specifically, to analysis of logs of data processing system operation.

To facilitate performance optimization, troubleshooting, and security of computer systems, computer systems typically record logs of events that occur during their operation. Conventionally, log analysis is a manual human-guided process, which is time-consuming, error-prone, and often inadequate for the large and multiple logs (often of differing formats) generated by large-scale systems. Automated log analysis techniques, on the other hand, can efficiently process vast amounts of log data to identify patterns, anomalies, and security threats. However, existing automated log analysis techniques often rely on predefined rules or keyword signatures to detect anomalies, which may not be effective for detecting novel or evolving performance problems, failure modes, or security threats about which a priori knowledge may not be available. Furthermore, automated log analysis techniques may generate a large number of false positives or false negatives, again requiring significant human intervention to validate (or discover) potential issues and to prioritize event handling.

### SUMMARY OF THE INVENTION

In view of the limitations of existing log analysis techniques, it would be useful and desirable to provide improved automated log analysis techniques that can automatically learn and adapt to changing system behavior, detect subtle anomalies, and generate accurate and actionable alerts.

In one or more embodiments, a computer-implemented technique of log analysis can be realized as a method, computer program product, or data processing system. In one example, each of a plurality of log entries in at least one log documenting operations performed by a plurality of computer system components of a computing environment is tokenized to form multiple tokens. Character ratio metrics for each of the multiple tokens are calculated. Based on the character ratio metrics, sentence vectors representing the plurality of log entries are formed. Based on the sentence vectors, an abnormal log entry indicative of deviation of a computer system component from its baseline cyclical behavior is detected in the at least one log, and an alert of the detection is generated.

### BRIEF DESCRIPTION OF THE DRAWINGS

FIG. 1 is a high-level block diagram of an exemplary data processing environment in accordance with one or more embodiments;

FIG. 2 is a high-level logical flowchart of an exemplary log analysis process in accordance with one or more embodiments; and

FIG. 3 is an example of an analysis data structure in accordance with one or more embodiments.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

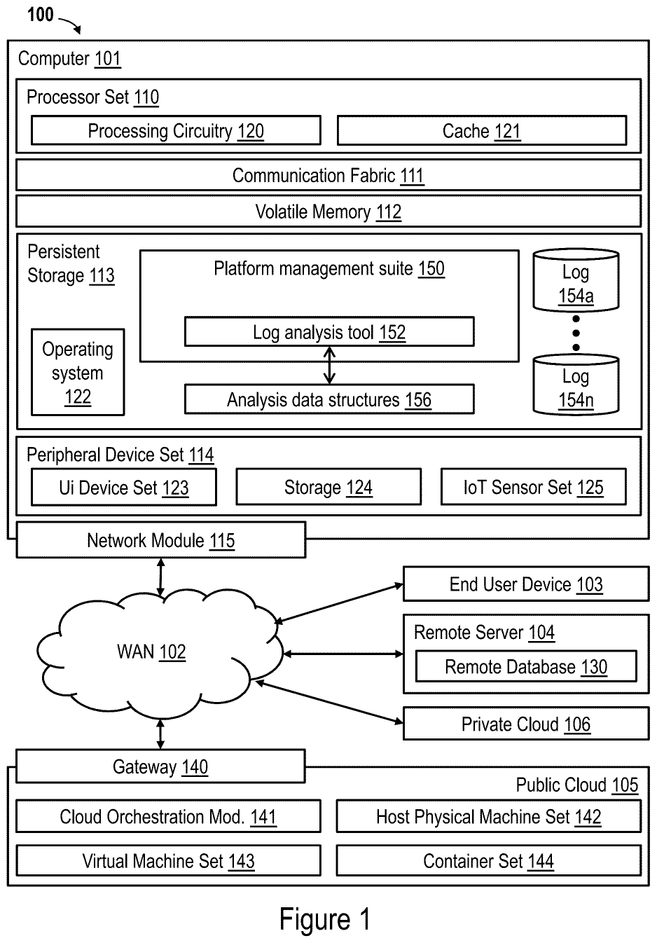

With reference now to FIG. 1, computing environment 100 contains an example of an environment for the execution of at least some of the computer code, such platform management suite 150, involved in performing the inventive methods. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and other code and data), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be implemented in platform management suite 150 in persistent storage 113. In some examples, platform management suite 150, which includes a log analysis tool 152, may be utilized to coordinate execution of workloads across one or more physical or virtual platforms in computing environment 100.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in platform management suite 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet-of-Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the Internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Those of ordinary skill in the art will appreciate that the architecture and components of a data processing environment can vary between embodiments. Accordingly, the exemplary computing environment 100 given in FIG. 1 is not meant to imply architectural limitations with respect to the claimed invention.

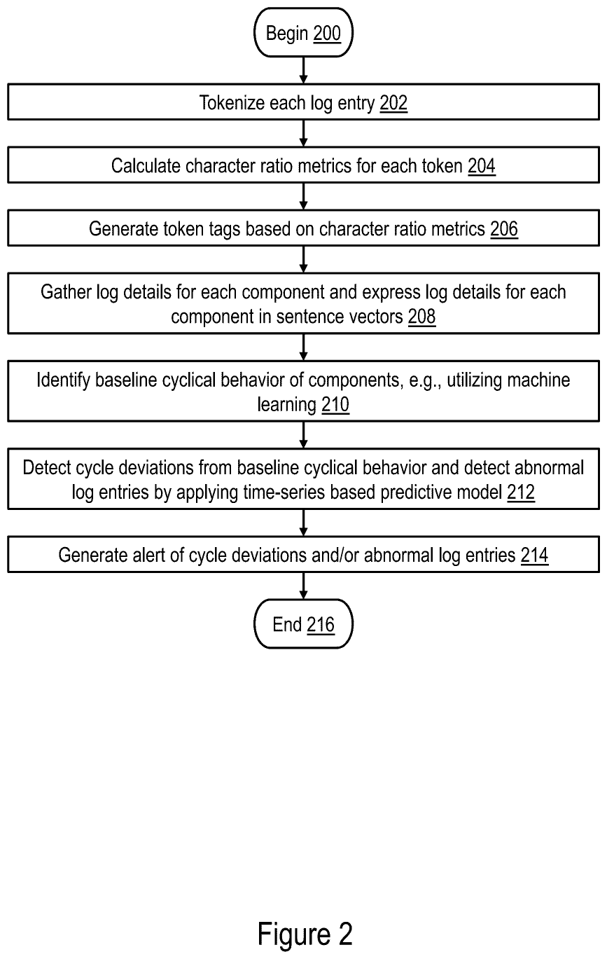

Referring now to FIG. 2, there is depicted a high-level logical flowchart of an exemplary log analysis process in accordance with one or more embodiments. The illustrated process can be performed, for example, by processing circuitry 120 through the execution of log analysis tool 152 of platform management suite 150. As known in the art, software and/or hardware within computing environment 100 generate logs 154a-154n to record events occurring during the operation of computing environment 100. These logs 154a-154n may record differing classes of events and may employ differing formatting and event nomenclature. As discussed further below, log analysis tool 152 can be utilized to analyze one or more computer logs 154a-154n and to detect events of interest (e.g., performance-impairing events, hardware and/or component failure events, security events, etc.) in individual logs 154 and/or across multiple logs 154.

The process of FIG. 2 begins at block 200 and then proceeds to block 202, which illustrates log analysis tool 152 tokenizing each of a plurality of log entries. Consider the following exemplary log entry in a log 154, which can record the initiation of a simulation run by a background process (daemon) of operating system 122:
2023 Apr. 3 23:16:13.711 Eastern Standard Time Info [1160:3184] Root Daemon::initApp( ):Starting SIM

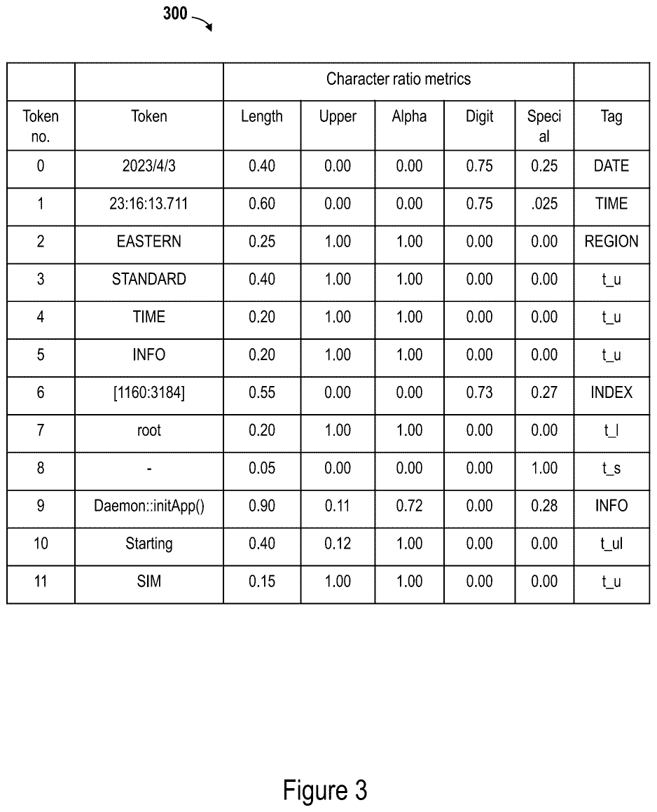

The process of tokenizing a log entry involves subdividing a text string in the log entry into smaller distinct non-overlapping units referred to in the art as “tokens.” In at least some conventional logs 154, the tokenization process subdivides the text string into tokens based on detection of token delimiters, such as spaces, commas (or other specific characters), or sub-strings. For example, using spaces as token delimiters, log analysis tool 152 can form from the above exemplary log entry the twelve tokens illustrated in token table 300 of FIG. 3. Token table 300 can be stored, for example, in persistent storage 113 as part of analysis data structures 156.

At block 204, log analysis tool 152 calculates one or more character ratio metrics for each token formed at block 202. For example, in one exemplary embodiment, log analysis tool 152 may calculate one or more of the following character ratio metrics: a normalized length ratio indicating a measure of the token length compared with other tokens, an uppercase character ratio providing the ratio of uppercase letters in the token to the total number of characters in the token, an alpha character ratio providing the ratio of alphabetic letters in the token to the total number of characters in the token, a digit character ratio providing the ratio of numerals in the token to the total number of characters in the token, a special characters ratio providing the ratio of special characters (e.g., “!”, “@”, “#”, “$”, “%”, “\hat{ }”, “&”, “*”, “(“, ”)”, “−”, “+”, etc.) in the token to the total number of characters in the token. As indicated in FIG. 3, log analysis tool 152 can be stored in token table 300.

Block 206 additionally illustrates log analysis tool 152 generating token tags based on the character ratio metrics determined at block 204. The generation of token tags can be expressed with the generalized function:

Tag=f(CRM_{length}, CRM_{upper,} CRM_{alpha,} CRM_{digit,} CRM_{special)}

For example, token table 300 illustrates some exemplary token tags applied to the tokens of the exemplary log entries. In this embodiment, the token tags include “DATE,” “TIME,” “REGION,” t_l (token of all lowercase letters), t_u (token of all uppercase letters), t_ul (token including both uppercase with lowercase letters), “INDEX” (token including no letters, at least one digit, and zero or more special characters), “INFO” (token including at least one letter, no digits, and at least one special character), t_s (index including only special character(s)). In other embodiments or use cases, alternative or additional tokens can be defined.

At block 208, log analysis tool 152 gathers log details for each system component (hardware or software) having at least one log entry in a log 154 and expresses the component log details in sentence vectors. In some examples, the log details include all (or selected) token tags within a predetermined or dynamically determined proximity of a reference to a computer system component (e.g., the system component name “Daemon::initApp( )”), up to and including all token tags of the log entry. In some embodiments, the proximity can further be limited to those token tags preceding the component name or following the component name. In some embodiments, the log details include only a subset of the different token tags (e.g., only DATE, TIME, and INDEX). As is known in the art, a sentence vector is a numeric representation of a statement, such as the component log details gathered at block 208. As should be appreciated, by limiting the formation of the sentence vectors to only selected token tags (e.g., by proximity, by order relative to the system component reference, or by token tag subset), slimmed sentence vectors are formed, reducing the log analysis workload and improving log analysis performance.

Log analysis tool 152 can then identify baseline cyclical behavior, if any, of the hardware or software components of computing environment 100 (block 210). In some embodiments, log analysis tool 152 identifies the baseline cyclical behavior by applying a pattern recognition machine learning tool to the sentence vectors. For example, log analysis tool 152 may determine at block 210 that Daemon::initApp( ) initiates a simulation run every evening of a standard work week at a predetermined time (e.g., at or about 23:16:13.711 Eastern Standard Time).

Based on the baseline cyclical behavior for each system component identified at block 210, log analysis tool 152 can additionally detect time cycle deviations and detect abnormal log entries by applying time-series-based predictive modeling (block 212). In at least some embodiments, a predictive modeling function can be expressed generally by:

P_{f}=f(W_{d}, W_{t,} t)
where W_{d} is a weighting applied to the day interval of the observed baseline time cycle of the system component, Wₜ is a weighting applied to the time-of-day interval of the observed baseline time cycle of the system component, and t represents the baseline time cycle of the system component. Log analysis tool 152 can refine this predictive modeling function over time, for example, based on feedback confirming and/or rejecting potential time cycle deviations detected at block 212. It should be appreciated that the disclosed technique enables detection of an abnormal log entry based on sentence vectors formed from log entries in different logs 154, which may be created by different log writers and which may employ different log formatting and nomenclature.

Based on the detection performed at block 212, log analysis tool 152 can generate an alert, for example, to a human system administrator of computing environment 100 and/or another software or firmware component of computing environment 100, providing notification of the detection of the cycle deviation and/or abnormal log entry (block 214). In various embodiments, the alert can include, for example, generation of a report, sending an email or other electronic communication, updating an administrator dashboard, and/or initiating execution of a daemon. Following block 214, the process of FIG. 2 thereafter terminates at block 216.

As has been described, in one or more embodiments, a computer-implemented technique of log analysis can be realized as a method, computer program product, or data processing system. In one example, each of a plurality of log entries in at least one log documenting operations performed by a plurality of computer system components of a computing environment is tokenized to form multiple tokens. Character ratio metrics for each of the multiple tokens are calculated. Based on the character ratio metrics, sentence vectors representing the plurality of log entries are formed. Based on the sentence vectors, an abnormal log entry indicative of deviation of a computer system component from its baseline cyclical behavior is detected in the at least one log, and an alert of the detection is generated.

In some embodiments, calculating character ratio metrics includes calculating at least a length metric and an alphabetic character metric.

In some embodiments, forming sentence vectors includes generating token tags based on the character ratio metrics and forming sentence vectors for a computer system component based on the token tags of tokens of log entries referencing the computer system component. In some embodiments, the sentence vectors are limited in size by restricting content of the sentence vectors to those token tags within a selected proximity, within a log entry, of the reference to the computer system component.

In some embodiments, a technique of log analysis includes identifying baseline cyclical behaviors of the plurality of computer system components based on the sentence vectors. In some embodiments, the baseline cyclical behaviors can be identified using machine learning.

In some embodiments, detecting the abnormal log entry includes detecting the abnormal log entry based on sentence vectors from the multiple different logs.

While the present invention has been particularly shown as described with reference to one or more preferred embodiments, it will be understood by those skilled in the art that various changes in form and detail may be made therein without departing from the spirit and scope of the invention.

The following definitions are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, system or apparatus that comprises a list of elements is not necessarily limited to only those elements but can include other elements not expressly listed or inherent to such composition, mixture, process, method, article, system or apparatus.

Additionally, the term “exemplary” is used herein to mean “serving as one example, instance or illustration.” Any embodiment or design described herein as “exemplary” is not necessarily to be construed as preferred or advantageous over other embodiments or designs. The terms “at least one” and “one or more” shall be understood to include any integer number greater than or equal to one, and the term “plurality” shall be understood to include any integer number greater than or equal to two. The term “coupled” shall include both indirect connection and a direct connection, unless specified otherwise in a particular case. The terms “about,” “substantially,” “approximately,” and variations thereof, are intended to include the degree of error associated with measurement of the particular quantity based upon the equipment available at the time of filing the application. For example, “about” can include a range of ±10% or ±5%, or ±2% of a given value.

The figures described herein and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. For the sake of brevity, conventional techniques related to making and using aspects of the invention(s) may or may not be described in detail herein, and many conventional implementation details are only mentioned briefly or are omitted entirely. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. A computer-implemented method of log analysis, the method comprising:
tokenizing each of a plurality of log entries in at least one log documenting operations performed by a plurality of computer system components of a computing environment, wherein the tokenizing includes forming multiple tokens of each of the plurality of log entries;
calculating character ratio metrics for each of the multiple tokens;
based on the character ratio metrics, forming sentence vectors representing the plurality of log entries; and
based on the sentence vectors, detecting, in the at least one log, an abnormal log entry indicative of deviation of a computer system component among the plurality of computer system components from its baseline cyclical behavior and providing an alert of the detecting.

2. The method of claim 1, wherein calculating character ratio metrics includes calculating at least a length metric and an alphabetic character metric.

3. The method of claim 1, wherein the forming sentence vectors includes:
generating token tags based on the character ratio metrics; and
forming sentence vectors for a computer system component based on the token tags of tokens of a log entries referencing the computer system component.

4. The method of claim 3, wherein forming sentence vectors includes:
limiting sizes of the sentence vectors by restricting content of the sentence vectors to those token tags within a selected proximity, within a log entry, of the reference to the computer system component.

5. The method of claim 1, further comprising:
identifying baseline cyclical behaviors of the plurality of computer system components based on the sentence vectors.

6. The method of claim 5, wherein identifying baseline cyclical behaviors includes identifying baseline cyclical behaviors using machine learning.

7. The method of claim 1, wherein:
the at least one log includes multiple different logs; and
the detecting includes detecting the abnormal log entry based on sentence vectors from the multiple different logs.

8. A computer program product, comprising:
a storage device; and
program code stored within the storage device and executable by processing circuitry of a computer to perform operations including:
tokenizing each of a plurality of log entries in at least one log documenting operations performed by a plurality of computer system components of a computing environment, wherein the tokenizing includes forming multiple tokens of each of the plurality of log entries;
calculating character ratio metrics for each of the multiple tokens;
based on the character ratio metrics, forming sentence vectors representing the plurality of log entries; and
based on the sentence vectors, detecting, in the at least one log, an abnormal log entry indicative of deviation of a computer system component among the plurality of computer system components from its baseline cyclical behavior and providing an alert of the detecting.

9. The computer program product of claim 8, wherein calculating character ratio metrics includes calculating at least a length metric and an alphabetic character metric.

10. The computer program product of claim 8, wherein the forming sentence vectors includes:
generating token tags based on the character ratio metrics; and
forming sentence vectors for a computer system component based on the token tags of tokens of a log entries referencing the computer system component.

11. The computer program product of claim 10, wherein forming sentence vectors includes:
limiting sizes of the sentence vectors by restricting content of the sentence vectors to those token tags within a selected proximity, within a log entry, of the reference to the computer system component.

12. The computer program product of claim 8, further comprising:
identifying baseline cyclical behaviors of the plurality of computer system components based on the sentence vectors.

13. The computer program product of claim 12, wherein identifying baseline cyclical behaviors includes identifying baseline cyclical behaviors using machine learning.

14. The computer program product of claim 8, wherein:
the at least one log includes multiple different logs; and
the detecting includes detecting the abnormal log entry based on sentence vectors from the multiple different logs.

15. A data processing system, comprising:
processing circuitry;
a storage device coupled to the processing circuitry; and
program code stored within the storage device and executable by processing circuitry of a data processing system to perform operations including:
tokenizing each of a plurality of log entries in at least one log documenting operations performed by a plurality of computer system components of a computing environment, wherein the tokenizing includes forming multiple tokens of each of the plurality of log entries;
calculating character ratio metrics for each of the multiple tokens;
based on the character ratio metrics, forming sentence vectors representing the plurality of log entries; and
based on the sentence vectors, detecting, in the at least one log, an abnormal log entry indicative of deviation of a computer system component among the plurality of computer system components from its baseline cyclical behavior and providing an alert of the detecting.

16. The data processing system of claim 15, wherein calculating character ratio metrics includes calculating at least a length metric and an alphabetic character metric.

17. The data processing system of claim 15, wherein the forming sentence vectors includes:
generating token tags based on the character ratio metrics; and
forming sentence vectors for a computer system component based on the token tags of tokens of a log entries referencing the computer system component.

18. The data processing system of claim 17, wherein forming sentence vectors includes:
limiting sizes of the sentence vectors by restricting content of the sentence vectors to those token tags within a selected proximity, within a log entry, of the reference to the computer system component.

19. The data processing system of claim 15, further comprising:
identifying baseline cyclical behaviors of the plurality of computer system components based on the sentence vectors.

20. The data processing system of claim 15, wherein:
the at least one log includes multiple different logs; and
the detecting includes detecting the abnormal log entry based on sentence vectors from the multiple different logs.
